(19) United States
(12) Patent Application Publication
(10) Pub. No.: US 2023/0171747 A1
(43) Pub. Date: Jun. 1, 2023

(54) SECURE DATA COMMUNICATION

(71) Applicant: Nokia Technologies Oy, Espoo (FI)

(72) Inventors: Peter SCHNEIDER, Holzkirchen (DE); Joerg SCHAEPPERLE, Stuttgart (DE)

(21) Appl. No.: 17/997,317

(22) PCT Filed: Apr. 29, 2021
(86) PCT No.: PCT/EP2021/061235

§ 371 Date: Oct. 27, 2022

(30) Foreign Application Priority Data
May 13, 2020 (FI) 20205478

(51) Int. Cl. H04W 72/044

(52) U.S. Cl. CPC H04W 72/044

(57) ABSTRACT

The present subject matter relates to a base station for a wireless communication system. The base station is configured to serve a set of user equipments. The base station comprises means configured for: allocating radio resources of the communication system for data communication between a specific subset of one or more user equipments of the set and the base station, enabling acquisition, by the subset of user equipments, of resource allocation information indicative of the allocated radio resources.

### TECHNICAL FIELD

Various example embodiments relate to computer networking, and more particularly to a base station for enabling exchange of data in a communication system.

### BACKGROUND

Radio interface jamming may be an inherent threat for wireless communication in communication systems such as the long term evolution (LTE) systems and the 5^{th} generation wireless networks (5G). 5G refers to a new generation of radio systems and network architecture. 5G is expected to provide higher bitrates and coverage than the current LTE systems. 5G is also expected to increase network expandability up to hundreds of thousands of connections.

### SUMMARY

Example embodiments provide a base station for a wireless communication system. The base station is configured to serve a set of user equipments. The base station comprises means configured for: allocating first radio resources of the communication system. The first radio resources are allocated for transmission of data by a specific subset of one or more user equipments of the set of user equipments to the base station. Additionally or alternatively, the first radio resources are allocated for reception of data by the subset of user equipments from the base station. The means is configured for enabling the subset of user equipments to acquire resource allocation information indicative of the first radio resources.

According to further example embodiments, a method used in a base station of a communication system is provided. The base station is configured to serve a set of user equipments. The method comprises: allocating first radio resources of the communication system for transmission of data by a specific subset of one or more user equipments, of the set of user equipments, to the base station and/or reception of data by the subset of user equipments from the base station, and enabling acquisition by the subset of user equipments of resource allocation information indicative of the first radio resources. The subset of user equipments may be selected from the set of user equipments.

According to further example embodiments, a computer program for a base station is provided. The base station is configured to serve a set of user equipments. The computer program comprises instructions for causing the base station for performing at least the following: allocating first radio resources of a communication system for transmission of data by a specific subset of one or more user equipments, of the set of user equipments, to the base station and/or reception of data by the subset of user equipments from the base station, and enabling the subset of user equipments to acquire resource allocation information indicative of the first radio resources.

According to further example embodiments, a user equipment is provided. The user equipment comprises means configured for: acquiring resource allocation information indicative of radio resources exclusively allocated for a specific set of user equipments including the user equipment and receiving data from a base station and/or sending data to the base station using the radio resources indicated in the resource allocation information.

According to further example embodiments, a method used in a user equipment is provided. The method comprises acquiring resource allocation information indicative of radio resources exclusively allocated for a specific set of user equipments including the user equipment and sending data to a base station and/or receiving data from the base station using the radio resources indicated in the resource allocation information.

According to further example embodiments, a computer program comprises instructions for causing a user equipment for performing at least the following: acquiring resource allocation information indicative of radio resources exclusively allocated for a specific set of user equipments including the user equipment and sending data to a base station and/or receiving data from the base station using the radio resources indicated in the resource allocation information.

According to further example embodiments, a system comprises a base station and a user equipment. The base station is configured to serve a set of user equipments. The base station is configured for allocating first radio resources of a communication system for transmission of data by a specific subset of one or more user equipments, of the set of user equipments, to the base station and/or reception of data by the subset of user equipments from the base station, and enabling acquisition by the subset of user equipments of resource allocation information indicative of the first radio resources. The user equipment is configured for acquiring said resource allocation information and sending data to the base station and/or receiving data from the base station using the first radio resources indicated in the resource allocation information.

According to further example embodiments, a method comprises allocating by a base station first radio resources of a communication system for transmission of data by a specific subset of one or more user equipments, of a set of user equipments served by the base station, to the base station and/or reception of data by the subset of user equipments from the base station, enabling acquisition by the subset of user equipments of resource allocation information indicative of the first radio resources; acquiring by a user equipment of the subset of user equipments said resource allocation information and sending data to the base station and/or receiving data from the base station using the first radio resources indicated in the resource allocation information.

### BRIEF DESCRIPTION OF THE DRAWINGS

The accompanying figures are included to provide a further understanding of examples, and are incorporated in and constitute part of this specification. In the figures:

FIG. 1 illustrates a part of an exemplifying radio access network;

FIG. 2 is a schematic illustration of a wireless communication system;

FIG. 3 is a flowchart of a method used in a base station according to an example of the present subject matter;

FIG. 4 is a flowchart of a method used in a user equipment (UE) according to an example of the present subject matter;

FIG. 5A illustrates an example of messages exchanged between UEs and the base station for an uplink synchronization procedure;

FIG. 5B illustrates an example of messages exchanged between UEs and the base station for an uplink synchronization procedure;

FIG. 6 is a is a block diagram illustrating a connection procedure according to an example of the present subject matter;

FIG. 7 is a block diagram showing an example of an apparatus according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

The communication system comprises one or more base stations, wherein each base station of the base stations serves user equipments located within the base station's geographical area of service or a cell. The base station and its coverage area may collectively be referred to as a cell. The communication system may support on or more radio access technologies (RATs). A radio access technology of the radio access technologies may, for example, be evolved universal terrestrial radio access (E-UTRA) or 5G new radio (NR), but it is not limited to, as a person skilled in the art may apply the present subject matter to other communication systems provided with necessary properties.

The time-frequency resources of the communication system may be used for carrying information. These resources may be termed physical channels. The physical channels may be specified for uplink and downlink transmission of data. The physical channels may, for example, comprise a physical downlink shared channel (PDSCH), physical downlink control channel (PDCCH), physical random access channel (PRACH) etc. For example, the available time and frequency resources, in the communication system, may be used in accordance with a multi-user configuration by dividing them into parts and sharing the parts amongst many users. The multi-user configuration may need a time and frequency synchronization between users and the base station. The synchronization may, for example, enable the user equipment to exchange user data with the base station. The synchronization may, for example, comprise an uplink time synchronization (referred to as uplink synchronization) that enables the user equipment to perform uplink transmissions to the base station. The uplink time synchronization may, for example, be performed or established during an initial access to the communication system. For example, the user equipment may be configured to perform an uplink synchronization procedure in order to establish the uplink time synchronization. The uplink synchronization procedure may, for example, be part of a random access procedure of LTE or 5G NR system.

A base station may be configured to provide (e.g. broadcast) information indicative of allocated resources by the base station. The user equipment may exchange data with the base station using allocated radio resources if it has access to information indicative of, or can predict, said radio resources. For example, the user equipment may be configured to monitor downlink data e.g. on the PDCCH, if it has access to information indicative of the resources allocated for the PDCCH. In another example, the establishment of the uplink synchronization may be performed by the user equipment if the user equipment knows the resources allocated by the base station for the uplink synchronization.

The user equipment may be configured to exchange data with the base station depending on its connection status. A user equipment (e.g. a subscribed user equipment) that may be served by the base station may have a connection status indicative of a state of connection of the user equipment to the base station. The state of the connection may, for example, be an idle state or connected state. The user equipment being in a connected state means that the user equipment is connected to the base station and can exchange data with the base station. The user equipment being in an idle state means that the user equipment is not connected to the base station. The idle state may, for example, be a radio resource control (RRC) IDLE state (RRC-IDLE). The connected state may, for example, be an RRC-CONNECTED state. The user equipment may establish the uplink synchronization if it has not yet acquired, or has lost, its uplink synchronization. For example, the user equipment may establish the uplink synchronization if the user equipment is:
in a connected state, handing over from its current serving cell to a target cell,
recovering from a radio link failure, or
transiting from an idle state to a connected state.

Hence, a user equipment (even of an attacker) having access to information on allocated resources may be configured to exchange data with the base station. For example, the user equipment may establish an uplink synchronization with the base station if that user equipment has access to information indicative of or can predict the radio resources allocated for performing the uplink synchronization.

The present subject matter may enable a secure exchange of data (e.g. during the uplink synchronization procedure) between the user equipment and the base station by using an unpredictable allocation of radio resources. For example, a set of resources may be allocated by the base station for reception and/or transmission, by the user equipment, of data. The allocated resources may provide frequent enough opportunities to user equipments of the communication system and an accurate synchronization estimation to adapt to different cell and network conditions without using unnecessary resources. The set of resources may be used by the user equipment to send data to and/or receive data from the base station. The set of resources may comprise a first type of resources and a second type of resources. The first type of resources may be called hidden resources and the second type of resources may be called public resources or non-hidden resources. In another example, the set of resources may comprise a single type of resources which are hidden resources. The public resources may, for example, be used by any user equipment subscribed with the communication system. A subscribed user equipment may be served by the base station. A subscribed user equipment is a user equipment that has a subscription with the communication system e.g. the user equipment comprises a valid universal subscriber identity module (USIM) containing the credentials of a subscription with the communication system. The hidden resources may be resources that can be revealed to and then be used by a specific (or selected) subset of user equipments. The specific subset of user equipments may, for example, be a subset of all user equipments subscribed with the communication system. The specific subset of user equipments may, for example, be a subset of a set of user equipments. The set of user equipments may be served by the base station. The remaining subset of user equipments of the set of user equipments may not be enabled, by the base station, to acquire the resource allocation information indicative of the hidden resources e.g. the remaining subset of user equipments may not be able to use the hidden resources to exchange data with the base station. In other words, the hidden resources may not be revealed, by the base station, to the remaining subset of user equipments. For example, the specific subset of user equipments may be user equipments authorized to access/use the hidden resources. The specific subset of user equipments may, for example, be user equipments of members of a police force. The specific subset of user equipments may, in another example, be automatically selected using a predefined selection criterion on subscription information of the subscribed user equipments of the communication system.

The set of resources may comprise at least one of: resources for establishment of an uplink synchronization between the specific subset of user equipments and the base station, resources for transmitting user data by the specific subset of user equipments and resources for transmitting control information (e.g. control information to establish an RRC connection). In one example, the set of resources may be time and frequency resources allocated for a common downlink and/or uplink channel that can be used by the subset of user equipments to perform a reception and/or transmission of data e.g. uplink transmissions involved in the uplink synchronization procedure. The channel may be a physical control channel such as a PRACH.

For example, the base station comprises means configured for: allocating first radio resources of the communication system for transmission of data by a specific subset of one or more user equipments, of the set of user equipments, to the base station and/or reception of data by the subset of user equipments from the base station. The allocating of the first radio resources for transmission of data by the specific subset of user equipments, to the base station and/or reception of data by the subset of user equipments from the base station comprises allocating the first radio resources for uplink synchronization between the subset of user equipments and the base station e.g. the first radio resources may be allocated for uplink transmissions and/or downlink transmission involved in (or required for) the establishment of the uplink synchronization.

The exchange of data between the user equipment and the base station may further be secured by a controlled signaling of the availability of the hidden resources to the user equipments. By contrast to a conventional system, the present subject matter may enable an improved and secure acquisition of information indicative of the hidden resources. In addition or alternatively to public information (such as the system information (SI)) which is descriptive of the public resources, the base station may provide the resource allocation information which is descriptive of the hidden resources. The resource allocation information may be provided so that a device which is different from the specific subset of user equipments may not acquire the resource allocation information. That is, the base station may enable an exclusive acquisition by the specific subset of user equipments of the resource allocation information. In one example, the resource allocation information may be provided separately from the public information. In another example, the public information may comprise a hidden part and a public part, wherein the hidden part comprises the resource allocation information and the public part is descriptive of the public resources. The base station may enable an exclusive acquisition by the specific subset of user equipments of the hidden part of the system information while the public part may be accessible by user equipments subscribed with the communication system. This selective access to the hidden resources may prevent jamming or flooding attacks by third party devices. For example, with the conventional system, an attacker can learn the configuration of the resources from the network. The learnt resources may be used by the attacker to transmit e.g. a preamble, so that the preamble sent by another user cannot be detected correctly, i.e. with the correct arrival time. The selective access to the hidden resources may have another advantage of saving resources that would otherwise be required by configuring each user equipment of the communication system to access the hidden resources.

The resource allocation information may be provided by the base station. For example, the base station comprises means configured for: allocating the set of radio resources for performance of at least part of the uplink synchronization procedure by the specific subset of user equipments, and enabling acquisition, by the subset of user equipments, of the resource allocation information indicative of the set of radio resources.

The present subject matter may further secure the data exchange between the user equipment and the base station (e.g. during the uplink synchronization procedure) by repeatedly updating or changing the hidden resources. According to an example, the base station may repeatedly perform the allocation of updated hidden resources and enable acquisition, by the subset of user equipments, of updated resource allocation information indicative of the updated hidden resources. That is, the update of the hidden resources comprises allocating by the base station updated hidden resources and enable acquisition, by the subset of user equipments, of updated resource allocation information indicative of the updated hidden resources. In one example, the update of the hidden resources may be performed in case at least one of the subset of user equipments is connected to the base station e.g. via the (previously allocated) hidden resources. In another example, the update of the hidden resources may be performed on a time periodic basis e.g. every hour. Before being sent or broadcasted, the updated resource allocation information of each iteration may be encrypted using key data which is different from the key data used to encrypt the resource allocation information in a previous iteration. The key data may, for example, comprise an encryption/decryption key. This may enable to change a key often enough to mitigate the risk caused by a compromise of the key.

According to an example, the enabling of the acquisition of the resource allocation information comprises encrypting by the base station the resource allocation information such that it is decryptable by the subset of user equipments, and broadcasting by the base station the encrypted resource allocation information.

The encryption of the resource allocation information may be performed in accordance with a predefined encryption scheme. Each user equipment of the specific subset of user equipments may decrypt the resource allocation information using key data provided to the user equipment. The key data may be passed to the user equipment in an encrypted message, e.g. an RRC message by the base station. In this case, the user equipment may be in a connected state with the base station, wherein the connection is performed using non-hidden resources. In another example, the key data may be acquired by the user equipment in an out-of-band way, allowing the user equipment to use hidden resources without relying on non-hidden resources. For example, the user equipment may receive the key data from another user equipment of the subset of user equipments, e.g. via Bluetooth, or via an optical transmission between a screen of one user equipment and a camera of the other user equipment. In another example, the user equipment may receive the key data from a server via a network such as a WiFi network to which the user equipment is connected. In this case, the communication system may be configured to provide the key data to the server. Since the user equipment may receive encrypted data from different base stations of the communication system, a coordination of the base stations concerning the key data, e.g. deriving it from some central key, may be used.

According to an example, the enabling of the acquisition of the resource allocation information comprises sending the resource allocation information to one or more user equipments, of the subset of user equipments, which are connected to the base station. The enabling of the acquisition of the resource allocation information comprises sending a unicast message to one or more user equipments, of the subset of user equipments, which are connected to the base station. This may enable a secure communication because a unicast message is delivered solely to an intended recipient and not to multiple ones. The one or more user equipments may be connected to the base station via non-hidden resources or via previously allocated hidden resources. For example, before a user equipment moves to an idle state, the user equipment may be notified of the location of the hidden resources that the user equipment can use to get a connected state again. The resource allocation information received at each user equipment of the one or more user equipments, in accordance with this example, may be indicative of hidden resources reserved exclusively for this each user equipment.

Alternatively, the resource allocation information received at each user equipment of the one or more user equipments may indicate hidden resources that can be used by each user equipment of the subset of user equipments.

According to an example, the base station may allocate further radio resources called public resources for uplink synchronization, and broadcast system information indicative of the public resources. Thus, a user equipment which is subscribed with the communication system may be able to acquire the system information. This may enable the base station to assign radio resources to allow terminals to establish a connection to the network of the communication system and publish the location (frequency, time) of these resources, but at the same time assign (e.g. in an unpredictable way) additional such resources for which the location is not published but revealed only to specific terminals. For example, one part of PRACH resources that is not hidden may be available to all subscribed user equipments, allowing user equipments to attach to the network of the communication system without any preconfigured, secret information. The second part of PRACH resources may be hidden. The amount of this second part may be adapted by the base station according to expected needs.

The present subject matter may enable a seamless integration with existing systems by making use of the system information. For example, the existing system information may be used to signal the availability of both the hidden resources and the public resources. The system information comprises parts or elements each being descriptive of a respective resource configuration. An element (named hidden element) of the system information may comprise the resource allocation information in encrypted format and another element may comprise information descriptive of the public resources in clear text.

According to an example, for enabling the establishment of the uplink synchronization, the hidden resources are all resources available for uplink synchronization in the communication system. This may make the communication system accessible only for the specific subset of user equipments. For example, all PRACH resources may be hidden, making the communication system accessible only for user equipments that are in possession of the hidden information.

According to an example, the hidden resources are randomly (or pseudo-randomly) selected from all resources available in the communication system. This may enable an unpredictable resource allocation and thus may further increase the secure aspect of the present subject matter. The base station may use a hardware random number generator to generate a sequence of allocations, or use a hardware random number generator only for generating a random seed that it is then used by a software-based pseudo random number generator (PRNG) to generate the sequence of allocations. For example, the allocation may be done by selecting the hidden PRACH resources randomly or pseudo-randomly from all possible resources. A subset of preambles can be assigned to the hidden PRACH resources and also revealed only to authorized user equipments.

According to an example, the hidden resources are available at a specific one time span, or several time spans, over a certain time interval.

According to an example, the base station further comprises a hardware random generator to generate, from all resources available in the communication system, a sequence of resource allocations. The hidden resources comprise the sequence of allocations, wherein the resource allocation information comprises a random seed for a random number generator, which allows the subset of user equipments to use the generator to determine the sequence of resource allocations. For example, each user equipment of the subset of user equipments has the same pseudo random number generator as the base station, so if it is informed about the seed used by the base station's pseudo random number generator, it may use the seed to produce the same sequence.

According to an example, the hidden resources are available in a cell served by the base station, or available in a group of cells comprising said cell.

According to an example, the resource allocation information is encapsulated in an RRC message. According to an example, the hidden resources are PRACH resources and the public resources are PRACH resources.

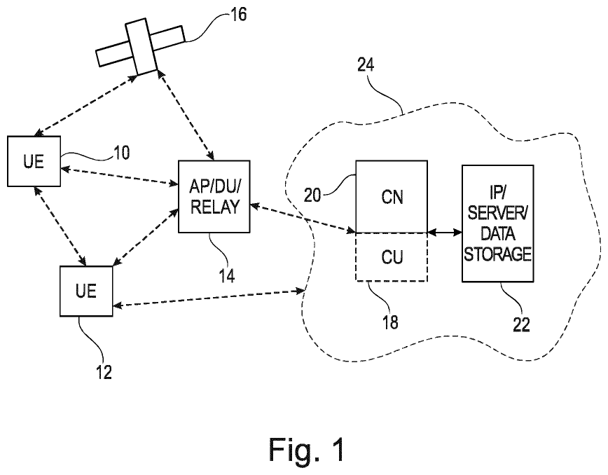

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 10 and 12. The devices 10 and 12 may, for example, be user devices. The devices 10 and 12 are configured to be in a wireless connection on one or more communication channels with a node 14. The node 14 is further connected to a core network 20. In one example, the node 14 may be an access node (such as (e/g)NodeB) 14 providing or serving devices in a cell. In one example, the node 14 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 20 (CN or next generation core NGC). For example, the (e/g)NodeB may connect to an access and mobility management function (AMF) and user plane function (UPF) in the control plane and user plane, respectively. Depending on the system, the counterpart on the CN side can be a serving gateway (S-GW, routing and forwarding user data packets), packet data network gateway (P-GW), for providing connectivity of devices (UEs) to external packet data networks, or mobile management entity (MME), etc.

The device (also called user device, UE, user equipment, user terminal, terminal device, etc.) illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station.

The device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilize cloud. In some applications, a device may comprise a user portable device with radio parts (such as a watch, earphones or eyeglasses) and the computation is carried out in the cloud. The device (or in some embodiments a layer 3 relay node) is configured to perform one or more of user equipment functionalities. The device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented. 5G enables using multiple input—multiple output (MIMO) antennas, many more base stations or nodes than an existing LTE system (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet as illustrated by the component referenced by reference numeral 22, or utilize services provided by them. The communication network may also be able to support the usage of cloud services, for example at least part of core network operations may be carried out as a cloud service (this is depicted in FIG. 1 by “cloud” 24). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 14) and non-real time functions being carried out in a centralized manner (in a centralized unit, CU 18).

It should also be understood that the distribution of labour between core network operations and base station operations may differ from that of the LTE or even be non-existent. Some other technology advancements probably to be used are Big Data and all-IP, which may change the way networks are being constructed and managed. 5G is being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 16 in the mega-constellation may cover several satellite-enabled network entities that create on-ground cells. The on-ground cells may be created via an on-ground relay node 14 or by a gNB located on-ground or in a satellite.

It is understandable for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. One of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

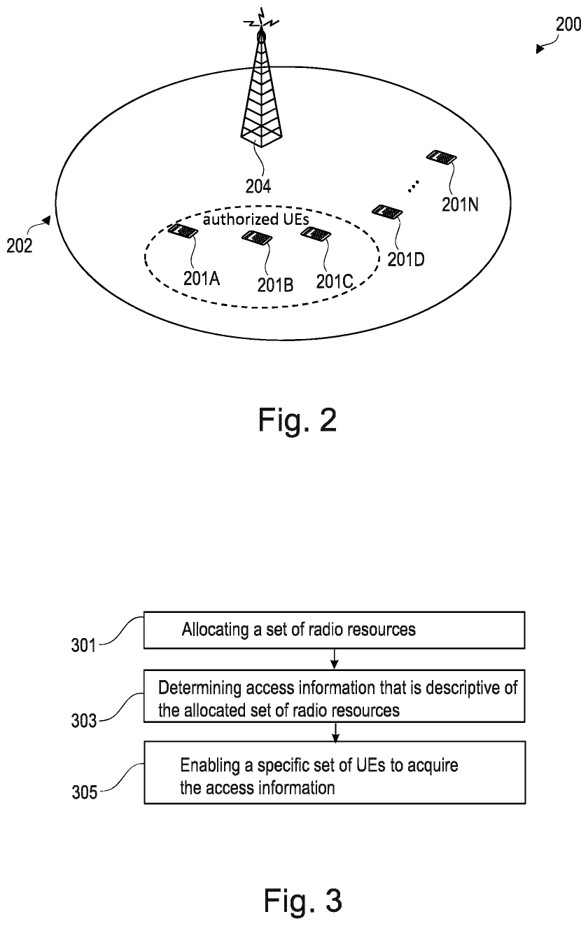

FIG. 2 is a schematic illustration of a wireless communication system 200. The communication system 200 may be configured to use a time division duplex (TDD) technique for data transmission.

For simplicity, communication system 200 is shown to include a single base station 204 but it is not limited to. The base station 204 may, for example, be eNodeB or gNB e.g. as described with reference to FIG. 1. The base station 204 may serve UEs 201A through 201 N within a respective geographical coverage area of service 202. The base station and its coverage area may collectively be referred to as a “cell”.

The base station 204 may communicate over a transmission medium with the UEs 201A through 201 N. The base station 204 may be a base transceiver station (BTS), and may include hardware that enables wireless communication with the UEs 201A through 201 N. The base station 204 may facilitate communication between the UEs and/or between the UEs and a network e.g. a core network of a cellular service provider.

The base station 204 may have a fixed number of time and frequency resources e.g. for uplink and/or downlink communication. For example, the base station 204 may have a fixed number of physical resource blocks (PRBs) defined in time and frequency for the uplink communication. The fixed number of resources may be referred to as all the available uplink resources for uplink and/or downlink communication in the cell 202.

Each UE of the UEs 201A through 201N may be configured to communicate using multiple wireless communication standards. For example, the UE might be configured to communicate using a 3GPP cellular communication standard, WLAN, Bluetooth, one or more global navigational satellite systems (GNSS, e.g., GPS or GLONASS), one and/or more mobile television broadcasting standards (e.g., ATSC-M/H or DVB-H), etc.

In this particular example, at least part of the UEs 201A through 201 N may need to securely receive data and/or send data to the base station 204 e.g. in order to establish an uplink synchronization with the base station 204, to setup an RRC connection etc. For example, for the uplink synchronization establishment, each UE of said at least part of the UEs may be in RRC-CONNECTED state, handing over from its current serving cell to a target cell or recovering from a radio link failure or transiting from RRC-IDLE state to RRC-CONNECTED state.

A subset of UEs e.g. 201A through 201C of the UEs 201A through 201N may be authorized in accordance with the present subject matter to access specific resources. The subset of the UEs 201A through 201C may be referred to as a specific or selected subset of UEs 201A through 201C.

FIG. 3 is a flowchart of a method used in a base station according to an example of the present subject matter. For the purpose of explanation, the method described in FIG. 3 may be implemented in the system illustrated in FIG. 2, but is not limited to this implementation.

The method starts at step 301, where the base station 204 allocates a set of radio resources for reception of data by the subset of the UEs 201A through 201C from the base station 204. Alternatively or additionally, the set of radio resources may be allocated for transmission of data by the subset of the UEs 201A through 201C to the base station 204. For example, in case of the uplink synchronization procedure, the transmission of data may comprise a transmission of a synchronization request e.g. a preamble and the reception of data may comprise a reception of a response (e.g. RACH response) from the base station. In another example, the transmission of data may comprise a transmission of an RRC connection request and the reception of data may comprise a reception of an RRC connection setup.

The base station 204 may allocate the set of radio resources from all available resources in the cell 202.

In a first allocation example, the set of resources comprises a single type of resources which are hidden resources. The hidden resources may exclusively be used by the subset of authorized UEs 201A through 201C. The hidden resources may not be known a priori to the non-authorized UEs 201 D through 201 N.

In a second allocation example, the set of resources may comprise hidden resources and public resources. The public resources may be used by authorized and non-authorized UEs. For example, each UE of the UEs 201A through 201N may be able to use the public resources in order to perform the uplink synchronization procedure and/or to setup an RRC connection. However, only authorized UEs 201A through 201C of the UEs 201A through 201 N may be able to use the hidden resources e.g. in order to perform the uplink synchronization procedure and/or to setup the RRC connection. Thus, the hidden resources may not be affected by a smart jamming or flooding attack against the public resources. This may, for example, enable all UEs 201A through 201 N to perform the uplink synchronization procedure while still enabling a secure uplink synchronization for authorized UEs 201A through 201C.

The allocation of the hidden resources in the first and second allocation examples may be performed in an unpredictable way so as to prevent a prediction or guessing of hidden resources by unauthorized users. For example, the base station 204 may use a hardware number random generator to generate, from all resources available in the cell 202, a sequence of locations in time and frequency resources, wherein the hidden resources comprise the sequence of locations.

The present subject matter may efficiently make use of the overall resources. For example, in case of an LTE or 5G NR system, the allocation of the hidden resources may further improve the resource usage efficiency, by, for example, reducing the size of the required PRACH resources. A smaller number of shorter preamble sequences may be used if the hidden resources are intended for a single UE or a small group of UEs. For example, the base station 204 may be configured to compare the number of UEs in the specific subset of UEs 201A through 201C with a predefined threshold. In case the number of UEs in the specific subset of UEs 201A through 201C is smaller than the predefined threshold, the base station 204 may define or generate preamble sequences which are shorter and smaller in number compared to preamble sequences of the conventional system.

After allocating the set of radio resources, the method then proceeds to step 303, where the base station 204 generates or determines access information that is descriptive of the allocated set of radio resources. In case the set of resources comprises a single type of resources which are hidden resources, the access information may be resource allocation information indicative of the hidden resources. In case the set of resources comprises hidden resources and public resources, the access information may comprise the resource allocation information indicative of the hidden resources and public information indicative of the public resources. The public information may, for example, be the system information (SI) that describes the PRACH resources.

The base station 204 may, for example, encapsulate the access information in at least one message. The at least one message may comprise parameters (and their values) which are indicative of the allocated set of radio resources. The at least one message may comprise one or more information elements indicative of the allocated set of radio resources. The at least one message may further comprise one or more additional information elements descriptive of other resources. An additional information element may be indicative of the identity of the cell, transmission bandwidth configuration in downlink, etc. The at least one message may, for example, be master information block (MIB) and system information block (SIB) messages. This may be advantageous as it may make use of existing and known allocated downlink resources for transmission of the at least one message.

In one example, the resource allocation information and the public information may be encapsulated in separate independent messages. For example, one or more messages, such as SIB messages, may be used to encapsulate the resource allocation information. The number of messages to encode the resource allocation information may be determined based on the number of distinct types of data transmissions for which the hidden resources are allocated (e.g. a first type of data transmissions may be transmissions involved in an uplink synchronization procedure, a second type of transmissions may be transmissions involved in an RRC connection setup etc.) The resource allocation information may be coded into the messages in a way that the time/order of their transmission can be arbitrary. In another example, the resource allocation information and the public information may be encapsulated in a same message. In this case, the at least one message may comprise a hidden part which has the parameters indicative of the hidden resources and a public part which is indicative of public resources and other resources such the identity of the cell etc. This may enable to hide the resource allocation information e.g. by encrypting it, so that is not accessible by the non-authorized UEs 201 D through 201 N.

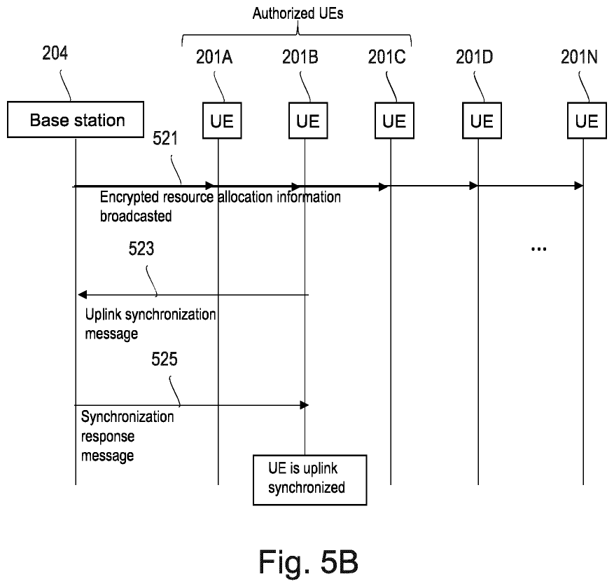

After determining the access information, the method proceeds to step 305, where the base station 204 provides the access information so that the resource allocation information may be acquired by the specific subset of the UEs 201A through 201C and may not be acquired by the non-authorized UEs 201 D through 201 N. The base station 204 may further provide the public information to all UEs 201A through 201N. For example, the access information may be encrypted before being provided in step 305. For example, the at least one message may be broadcasted in step 305 if the resource allocation information is encrypted in the message. In another example, the at least one message may be sent as a unicast message to the subset of UEs 201A through 201C in step 305. FIGS. 5A-B provide an example implementation of step 305.

The present subject matter may particularly be advantageous in case of an LTE or 5G NR system. For example, the method of FIG. 3 may enable to have in addition to the PRACH resources that are allocated and published in the system information broadcast, hidden PRACH resources within the overall uplink resources, the location of which is only known to certain authorized UEs, which subsequently can use these hidden resources (e.g. when changing from an idle state to a connected state). This allows to configure RACH resources that are safe against smart jammers for mission critical devices. For example, the effort of a smart jammer aiming at causing a DoS in the cell 202 by making the PRACH unavailable is significantly increased. This may force the attacker to jam the complete uplink bandwidth all the time, turning the smart jamming attack into barrage jamming.

In one example, the method steps 301 to 305 may be repeated (e.g. every hour), wherein the access information of each iteration may be encrypted using key data which is different from the key data used to encrypt the access information in a previous iteration. The key data may, for example, comprise an encryption/decryption key.

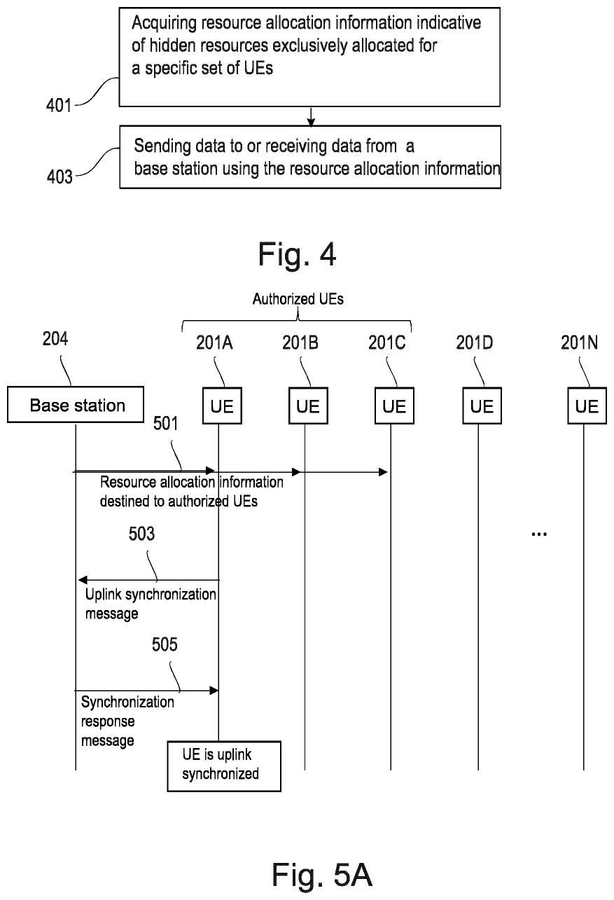

FIG. 4 is a flowchart of a method used in a user equipment of the authorized user equipments 201A through 201C according to an example of the present subject matter. For the purpose of explanation, the method described in FIG. 4 may be implemented in the system illustrated in FIG. 2, but is not limited to this implementation.

The method starts at step 401, where the user equipment e.g. 201A acquires resource allocation information indicative of hidden resources. The hidden resources may comprise resources allocated for transmission of specific data by the UE 201A to the base station 204. Alternatively or additionally, the hidden resources may comprise resources allocated for reception of specific data by the UE 201A from the base station 204.

In a first information acquisition example, the resource allocation information may be encrypted information which is broadcasted by the base station 204. The UE 201A may acquire the resource allocation information by intercepting the resource allocation information. The UE 201A may have access to key data that enables the UE 201A to decrypt the intercepted and encrypted resource allocation information.

In a second information acquisition example, the resource allocation information may be sent by the base station 204 in destination (i.e. not broadcasted) to the UE 201A that is connected to the base station 204. The UE 201A may read the received resource allocation information. For example, the UE 201A may receive the resource allocation information in a unicast message. This may enable a secured communication of the resource allocation information by directly addressing such information to the UE 201A. The submission of the resource allocation information may further be secured by performing the submission over an encrypted connection. That is, the resource allocation information may be encrypted before being sent to the UE 201A. The UE 201A may use key data to decrypt the encrypted resource allocation information.

In a third information acquisition example, the resource allocation information may be received by the UE 201A from another UE of the authorized UEs e.g. 201 B that has received the resource allocation information e.g. in accordance with the first or second information acquisition example.

In a fourth information acquisition example, the resource allocation information may be received by the UE 201A from a server that stores the resource allocation information. For example, the base station 204 may be configured to automatically store the resource allocation information in the server upon allocating the set of radio resources.

The key data needed to decrypt the encrypted resource allocation information may be provided to the UE 201A as described with the provision of the resource allocation information in the second, third or fourth information acquisition example.

After acquisition of the resource allocation information by the UE 201A, the method then proceeds to step 403, where the UE 201A reads the resource allocation information for determining hidden resources. The hidden resources may be used by the UE 201A to send data and/or receive data from the base station 204 depending on the allocated resources. For example, in case the hidden resources are allocated for an uplink synchronization procedure, the UE 201A may be configured as follows. The UE 201A may determine in which subframe (frequency, time) of the hidden resources a preamble message may be sent. The UE 201A may transmit a preamble to the base station 204 using the hidden resources. The base station 204 uses the preamble to determine the appropriate timing advance parameter adjustment, which is fed back in a response to the UE 201A. Additionally or alternatively, the UE 201A may use the hidden resources to listen to a downlink channel in order to receive the response from the base station 204 so it can use the response to get uplink synchronized and perform initial uplink data transmissions. The initial uplink data transmission may be performed by the UE 201A that is initially accessing a cell, or was otherwise operating in an idle state prior to performing the data transmission.

FIG. 5A illustrates an example of messages exchanged between UEs and the base station for an uplink synchronization procedure. For the purpose of explanation, the method described in FIG. 5A may be implemented in the system illustrated in FIG. 2, but is not limited to this implementation.

The base station 204 sends (501) resource allocation information to the specific subset of UEs 201A through 201C. The resource allocation information may be sent in one or more messages as described herein. The resource allocation information may be sent individually (e.g. in unicast messages) to the specific subset of UEs 201A through 201C. Resources revealed or sent to a UE individually may be reserved exclusively for this UE, or may be used (shared) by several authorized UEs. The less sharing, the higher is the assurance that the attacker may not learn the allocation of the resources, e.g. via an authorized UE that has been compromised and is thus under control of an attacker. The more sharing, the higher is the resource usage efficiency.

The remaining UEs 201D through 201N may not receive the resource allocation information as they are not authorized UEs. The specific subset of UEs 201A through 201C may thus be able to decode or read the resource allocation information and thus perform uplink synchronization if needed. Assuming for simplification of the description that only UE 201A needs uplink synchronization as it may have not yet acquired its uplink synchronization with the base station 204, or has lost, its uplink synchronization.

In a first step (503) of the uplink synchronization procedure, the UE 201A transmits a synchronization message to the base station 204 using hidden resources indicated in the resource allocation information. In case of an LTE or 5G NR system, the synchronization message may be the PRACH preamble. The PRACH preamble may be configured according to one of the predefine formats.

In response to decoding the synchronization message, the base station 204 transmits to the UE 201A a second message which is a synchronization response message (505). The synchronization response message may, for example, be a random access response (RAR). The uplink synchronization procedure may comprise steps 503 and 505. The UE 201A may use during the uplink synchronization procedure the content of the synchronization response message to become uplink synchronized with the base station 204.

In response to decoding the second message, the UE 201A may, for example, transmit a third message. The content of the third message may be different in different contexts, e.g., may depend on the purpose for which the uplink synchronization procedure has been invoked. For example, the third message may include an RRC request or a scheduling request (SR). In response to receiving the third message, the base station 204 may transmit to the UE 201A a fourth message e.g., a contention resolution message.

FIG. 5B illustrates an example of messages exchanged between UEs and the base station for an uplink synchronization procedure. For the purpose of explanation, the method described in FIG. 5B may be implemented in the system illustrated in FIG. 2, but is not limited to this implementation.

The base station 204 broadcasts (521) the resource allocation information. The resource allocation information may be broadcasted in one or more messages as described herein. In one example, the message containing the resource allocation information may be encrypted before it is broadcasted. This may enable the base station to broadcast the allocation of the hidden resources, but in an encrypted way that can be decrypted only by UEs authorized to access the hidden resources.

As indicated in FIG. 5B, the UEs 201A through 201N may be able to receive the broadcasted resource allocation information. However, the other non-authorized UEs 201 D through 201 N may not decrypt the encrypted resource allocation information. The specific subset of UEs 201A though 201C are configured to decrypt the resource allocation information. The specific subset of UEs 201A through 201C may thus be able to decode or read the resource allocation information and thus establish uplink synchronization, if needed, using the hidden resources. Assuming for simplification of the description that only UE 201 B needs uplink synchronization as it may have not yet acquired its uplink synchronization with the base station 204, or has lost, its uplink synchronization.

In a first step (523) of the uplink synchronization procedure, the UE 201 B transmits a synchronization message to the base station 204 using hidden resources indicated in the decrypted resource allocation information. In case of an LTE or 5G NR system, the synchronization message may be the PRACH preamble. The PRACH preamble may be configured according to one of the predefine formats.

In response to decoding the synchronization message, the base station 204 transmits to the UE 201 B a second message which is a synchronization response message (525). The synchronization response message may, for example, be a random access response (RAR). The uplink synchronization procedure may comprise steps 523 and 525. The UE 201A may use during the uplink synchronization procedure the content of the synchronization response message to become uplink synchronized with the base station 204.

In response to decoding the second message, the UE 201B may transmit a third message. The content of the third message may be different in different contexts, e.g., may depend on the purpose for which the uplink synchronization procedure has been invoked. For example, the third message may include an RRC request or a scheduling request. In response to receiving the third message, the base station 204 may transmit to the UE 201 B a fourth message e.g., a contention resolution message.

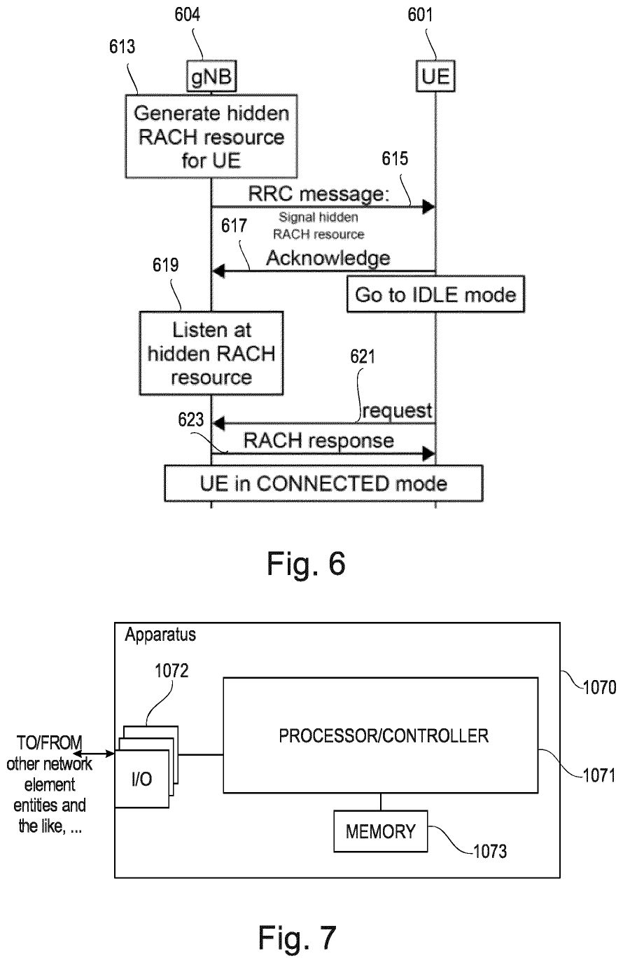

FIG. 6 illustrates an example of messages exchanged between a UE 601 and a gNB 604 for an uplink synchronization procedure. FIG. 6 shows an example implementation using RRC signaling in a 5G NR system. The example of FIG. 6 is given for only a single UE, but the RACH resource may also be shared by a group of UEs. In the example, the resources are provided in advance to critical devices where anti-jamming measures may be activated, e.g. while the devices are in connected state.

The gNB 604 may generate (613) hidden RACH resources for the UE 601. The hidden resources may be signaled (615) by the gNB 604 in an RRC message to the UE 601 in RRC CONNECTED state. The hidden RACH resources may be resources available for PRACH transmission. The resources available for PRACH transmission may be provided to the UE 601 as part of dedicated RRC signaling in case of e.g. handover. For example, the hidden RACH resources may be revealed to the UE 601 in connected state via an encrypted RRC message. And the provided system information may be acquired and decoded by the UE in order to perform the uplink synchronization procedure.

The UE 601 may acknowledge (617) the reception of the RRC message and may then switch to the RRC IDLE state. After receiving the acknowledgment, the gNB 604 may listen (619) to the hidden RACH resources.

The UE 601 may send (621) a request using the hidden resources. In response to receiving the request, the gNB 604 may send (623) a RACH response. The request and the RACH response may form the uplink synchronization procedure. The UE 601 may switch to the RRC CONNECTED state after the uplink synchronization procedure is completed.

In FIG. 7, a block circuit diagram illustrating a configuration of an apparatus 1070 is shown, which is configured to implement at least part of the present subject matter. It is to be noted that the apparatus 1070 shown in FIG. 6 may comprise several further elements or functions besides those described herein below, which are omitted herein for the sake of simplicity as they are not essential for the understanding. Furthermore, the apparatus may be also another device having a similar function, such as a chipset, a chip, a module etc., which can also be part of an apparatus or attached as a separate element to the apparatus 1070, or the like. The apparatus 1070 may comprise a processing function or processor 1071, such as a central processing unit (CPU) or the like, which executes instructions given by programs or the like related to a flow control mechanism. The processor 1071 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 1072 denotes transceiver or input/output (I/O) units (interfaces) connected to the processor 1071. The I/O units 1072 may be used for communicating with one or more other network elements, entities, terminals or the like. The I/O units 1072 may be a combined unit comprising communication equipment towards several network elements, or may comprise a distributed structure with a plurality of different interfaces for different network elements. Reference sign 1073 denotes a memory usable, for example, for storing data and programs to be executed by the processor 1071 and/or as a working storage of the processor 1071.

The processor 1071 is configured to execute processing related to the above described subject matter. In particular, the apparatus 1070 may be configured to perform at least part of the method as described in connection with FIG. 3, 4, 5A, 5B, or 6.

For example, the processor 1071 is configured to: allocate radio resources, hereinafter called hidden resources, of a communication system for exchange of data between a specific subset of one or more user equipments and a base station, and enable acquisition, by the subset of user equipments, of resource allocation information indicative of the hidden resources.

In another example, the processor 1071 is configured to: acquire resource allocation information indicative of radio resources exclusively allocated for a specific subset of user equipments and sending data to and/or receiving data from a base station using the radio resources indicated in the resource allocation information.

The present subject matter may comprise following clauses.

Clause 1: A method used in a base station of a communication system, the base station being configured to serve a set of user equipments, comprising: allocating first radio resources (named hidden resources) of the communication system for transmission of data by a specific subset of one or more user equipments of the set of user equipments to the base station and/or reception of data by the subset of user equipments from the base station, and enabling acquisition by the subset of user equipments of resource allocation information indicative of the first radio resources.
Clause 2: The method of clause 1, the first radio resources comprising at least one of: resources for establishment of an uplink synchronization between the specific subset of user equipments and the base station, resources for transmitting user data by the specific subset of user equipments and resources for transmitting control information by the base station or by the specific subset of user equipments.
Clause 3: The method of clause 1 or 2, further comprising repeatedly performing the allocating and the enabling steps, thereby repeatedly changing the hidden resources.
Clause 4: The method of clause 1, 2 or 3, the enabling of the acquisition of the resource allocation information comprising encrypting the resource allocation information such that it is decryptable by the subset of user equipments, and broadcasting the encrypted resource allocation information.
Clause 5: The method of clause 1, 2 or 3, the enabling of the acquisition of the resource allocation information comprising sending the resource allocation information to one or more user equipments, of the subset of user equipments, which are connected to the base station.
Clause 6: The method of clause 5, the sending of the resource allocation information being performed over an encrypted connection.
Clause 7: The method of any of the preceding clauses 1-6, further comprising allocating second radio resources for transmission of data by the set of user equipments to the base station and/or reception of data by the set of user equipments from the base station, and broadcasting information indicative of the second radio resources.
Clause 8: The method of clause 7, the broadcasted information comprising the resource allocation information, wherein the resource allocation information is in encrypted format.
Clause 9: The method of any of the preceding clauses 2-8, the first radio resources being all resources available for uplink synchronization in the communication system.
Clause 10: The method of any of the preceding clauses 1-9, further comprising randomly selecting the first radio resources from all resources available in the communication system.
Clause 11: The method of any of the preceding clauses 1-10, the first radio resources being allocated for a specific one time span, or for several time spans, over a certain time interval.
Clause 12: The method of any of the preceding clauses 1-11, further comprising using a hardware random number generator to generate from all resources available in the communication system, a sequence of allocations in time and frequency resources, the first radio resources being allocated in accordance with the sequence of allocations.
Clause 13: The method of any of the preceding clauses 1-11, further comprising using a hardware random number generator to generate a random seed which allows the subset of user equipments to generate a sequence of allocations in time and frequency resources for the uplink synchronization, wherein the resource allocation information comprises the random seed.
Clause 14: The method of any of the preceding clauses 1-13, the first radio resources being available in at least a cell served by the base station.
Clause 15: The method of any of the preceding clauses 1-14, further comprising encapsulating the resource allocation information in a radio resource control, RRC, message and enabling acquisition, by the subset of user equipments, of the RRC message.
Clause 16: The method of any of the preceding clauses 1-15, wherein the method is performed in a random access procedure (RACH).
Clause 17: A user equipment comprising means configured for: acquiring resource allocation information indicative of radio resources exclusively allocated for a specific set of user equipments including the user equipment and sending data to and/or receiving data from a base station using the resource allocation information.
Clause 18: The user equipment of clause 17, the means being configured for acquiring the resource allocation information comprising receiving the resource allocation information in encrypted format, and decrypting the encrypted resource allocation information. For example, the means of the user equipment is configured for acquiring the resource allocation information comprising receiving an encrypted broadcasted message, from the base station, wherein the message comprises the resource allocation information.
Clause 19: The user equipment of clause 18, the means being configured for receiving a decryption key from a server or from a user equipment of the set of user equipments or from the base station in case the user equipment is connected to the base station, and using the decryption key to perform the decryption.
Clause 20: The user equipment of clause 17, the user equipment being connected to the base station, the means being configured for acquiring the resource allocation information comprising receiving the resource allocation information destined (or addressed) to the user equipment from the base station. For example, the means of the user equipment is configured for acquiring the resource allocation information comprising receiving a unicast message from the base station, wherein the message comprises the resource allocation information.
Clause 21: The user equipment of clause 17, the means being configured for acquiring the resource allocation information comprising receiving the resource allocation information from a user equipment of the set of user equipments or from a sever.
Clause 22: The user equipment of any of the preceding clauses 17, 18, 19 or 21, wherein the user equipment is not yet uplink synchronized, or has lost, its uplink synchronization.
Clause 23: The user equipment of any of the preceding clauses 17-22, the resource allocation information comprising a random seed, the means being configured for generating, using the random seed and a random number generator, a sequence of allocations in time and frequency resources for uplink synchronization, the sequence of allocations being the radio resources.
Clause 24: The user equipment of any of the preceding clauses 17-23, the means being configured for performing the uplink synchronization comprising: sending to the base station an uplink synchronization request message on an uplink carrier indicated in the resource allocation information, the means being further configured for receiving a response message from the base station, the response message indicating that the user equipment is uplink synchronized.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device.

‘Computer memory’ or ‘memory’ is an example of a computer-readable storage medium. Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1-23. (canceled)

24. A base station for a wireless communication system, the base station being configured to serve a set of user equipments, the base station comprising means configured for: allocating first radio resources of the communication system for transmission of data by a specific subset of user equipments, of the set of user equipments, to the base station and/or reception of data by the subset of user equipments from the base station; enabling acquisition, by the subset of user equipments, of resource allocation information indicative of the first radio resources.

25. The base station of claim 24, wherein the first radio resources comprise at least one of: resources for establishment of an uplink synchronization between the specific subset of user equipments and the base station, resources for transmitting user data by the specific subset of user equipments and resources for transmitting control information by the base station or by the specific subset of user equipments.

26. The base station of claim 24, the means being configured for repeatedly performing the allocating and the enabling, thereby repeatedly changing the first radio resources.

27. The base station of claim 24, the means being configured for enabling the acquisition of the resource allocation information by encrypting the resource allocation information such that it is decryptable by the subset of user equipments, and broadcasting the encrypted resource allocation information.

28. The base station of claim 24, the means being configured for enabling the acquisition of the resource allocation information by sending the resource allocation information to one or more user equipments, of the subset of user equipments, which are connected to the base station.

29. The base station of claim 28, the means being configured for performing the sending of the resource allocation information over an encrypted connection.

30. The base station of claim 24, the means being configured for allocating second radio resources for transmission of data by the set of user equipments to the base station and/or reception of data by the set of user equipments from the base station, and broadcasting information indicative of the second radio resources.

31. The base station of claim 30, the broadcasted information comprising the resource allocation information, wherein the resource allocation information is in encrypted format.

32. The base station of claim 24, the first radio resources being all resources available for uplink synchronization in the communication system.

33. The base station of claim 24, the means being configured for randomly selecting the first radio resources from all resources available in the communication system.

34. The base station of claim 24, the first radio resources being allocated for a specific one time span, or for several time spans, over a certain time interval.

35. The base station of claim 24, further comprising a hardware random number generator to generate, from all resources available in the communication system, a sequence of allocations in time and frequency resources, the first radio resources being allocated in accordance with the sequence of allocations.

36. The base station of claim 24, further comprising a hardware random number generator to generate a random seed which allows the subset of user equipments to generate a sequence of allocations in time and frequency resources, wherein the resource allocation information comprises the random seed.

37. The base station of claim 24, the first radio resources being available in at least a cell served by the base station.

38. The base station of claim 24, the means being configured for encapsulating the resource allocation information in a radio resource control, RRC, message and enabling acquisition, by the subset of user equipments, of the RRC message.

39. The base station of claim 24, wherein the means comprises at least one processor; and at least one memory including computer program code, the at least one memory and the computer program code being configured to, with the at least one processor, cause the performance of the base station.

40. A computer program for a base station, the base station being configured to serve a set of user equipments, the computer program comprising instructions for causing the base station for performing at least the following: allocating first radio resources of a communication system for transmission of data by a specific subset of user equipments, of the set of user equipments, to the base station and/or reception of data by the subset of user equipments from the base station, and enabling the subset of user equipments to acquire resource allocation information indicative of the first radio resources.

41. A user equipment comprising means configured for: acquiring resource allocation information indicative of radio resources exclusively allocated for a specific set of user equipments including the user equipment and receiving data from a base station and/or sending data to the base station using the radio resources indicated in the resource allocation information.

42. The user equipment of claim 41, wherein the means comprises at least one processor; and at least one memory including computer program code, the at least one memory and the computer program code being configured to, with the at least one processor, cause the performance of the user equipment.
